(19) United States
(12) Patent Application Publication
(10) Pub. No.: US 2014/0270888 A1
(43) Pub. Date: Sep. 18, 2014

(54) TWO-COLOR BALL POINTED PEN

(71) Applicant: SunYoung Yeum, Busan (KR)

(72) Inventor: SunYoung YEUM, Bucheon-si (KR)

(73) Assignee: SunYoung Yeum, Busan (KR)

(21) Appl. No.: 14/187,486

(22) Filed: Feb. 24, 2014

(30) Foreign Application Priority Data
Mar. 14, 2013 (KR) 20-2013-0001913

(51) Int. Cl. B43K 27/12; B43K 7/00; B43K 7/02

(52) U.S. Cl. CPC B43K 27/12; B43K 7/02; B43K 7/00
USPC 401/17; 401/35

(57) ABSTRACT

A two-color ball pointed pen having two pen cartridges with different colors in one case allows a user to easily and rapidly select and use a wanted color. The two-color ball pointed pen includes: two-color pen cartridges(3,3′) joined to one side of a case(1); a highlighter pen(5) joined to the other side of the case(1); and a transparent cap(4) joined to an assembly hole(11) of one side of the case(1) to which the two-color pen cartridges(3,3′) are joined so as to allow a user to see colors of the two-color pen cartridges(3,3′) from the outside.

### BACKGROUND

The present invention relates to a two-color ball pointed pen, and more particularly, to a two-color ball pointed pen, which two pen cartridges with different colors are inserted into one body so that a user can use two colors using just one ball pointed pen and which allows the user to rapidly and easily use a wanted color while writing because the user can easily and rapidly distinguish and select the colors of the pen cartridges.

In general, a pen cartridge with a single color is inserted into one writing instrument, and hence, a user has to prepare many writing instruments with different colors in order to use many colors.

In order to solve the problem of the inconvenience, pen cartridges with various colors must be inserted into one body, and two-color ball pointed pens of various structures in which pen cartridges with at least two colors are embedded in a single body of a ball pointed pen have been invented.

Korean Utility Model Laid-open No. 1996-20773, Korean Utility Model Publication No. 20-1982-002657, and Japanese Patent Laid-open No. 2004-276501 respectively disclose two-color ball pointed pens, in which two pen cartridges with different colors are joined to a single body. Korean Utility Model Publication No. 20-1982-000649 discloses a writing instrument in which three pen cartridges with different colors are embedded in a single pen body so that a user can write in three colors.

However, such a conventional writing instrument has a disadvantage in that the user feels inconvenience in carrying and in writing in the user's hand because the writing instrument is bulky since ball pointed pens respectively having pen cartridges with two colors are joined as one writing instrument.

Moreover, multi-color ball pointed pens in each of which at least two pen cartridges are embedded in a single body in such a manner that the pen cartridge with a wanted color is advanced and retracted have been developed as follows.

Korean Utility Model Publication No. 20-1985-000304, Korean Utility Model Laid-open Nos. 20-2010-0013002, 20-2012-0008083 and 20-2009-0011985, Korean Patent Laid-open No. 10-2010-0118794, and Japanese Patent Laid-open No. 2000-233596 disclose writing instruments each of which includes a plurality of pen cartridges embedded in a single body and a spring resiliently mounted in such a way as to advance and retract the pen cartridge with a wanted color.

However, such a writing instrument having the structure that a plurality of pen cartridges are embedded in the single body and the pen cartridge with a wanted color is advanced has several disadvantage in that its structure is complicated, in that manufacturing cost is expensive, and in that the writing instrument is frequently out of order and the user feels inconvenience in carrying and writing in his or her hand because it is bulky due to the structure to advance and retract the plural pen cartridges.

Particularly, the writing instrument in which at least two pen cartridges are embedded has manipulation buttons disposed at the upper portion thereof for advancing and retracting each of the pen cartridges so that the user can distinguish colors of the pen cartridges through the external manipulation buttons. Therefore, the user can easily distinguish the colors, but the user cannot keep the writing posture because the user has to select and convert a wanted color while writing by pushing the manipulation buttons with one of the fingers and cannot write rapidly and use conveniently because the user has to push the manipulation buttons with the finger whenever he or she changes colors of the ball pointed pen.

Besides the above-mentioned writing instruments, Korean Utility Model Laid-open No. 20-1998-0007086 discloses a twin pen having a combined ball pointed pen and highlighter pen which includes holders fixed to both sides of a case for fixing a pen cartridge of a ball pointed pen and a highlighter pen filter.

The twin pen having the highlighter pen allows the user to use the ball pointed pen and the highlighter pen together because having the ball pointed pen and the highlighter pen formed at both sides of the case. However, the user cannot use it in various colors because the twin pen does not have pen cartridges with various colors in one case. Additionally, even though two pen cartridges with different colors are embedded in the single case, the user cannot rapidly change the color into a wanted color while writing because he or she cannot check the color of the pen.

Korean Patent Laid-open No. 10-2011-037822 discloses a multi-cartridge pen that at least three pen cartridges are inserted in a case in such a way that the pen cartridges inclinedly protrude to the outside from an end portion of the case so that the user can use many pens.

The multi-cartridge pen has many pen cartridges in one case, but does not have any highlighter pen.

Moreover, the multi-cartridge pen has several disadvantages in that it has no means to allow the user to easily check colors of the pen cartridges at any time while writing, and in that the user cannot rapidly converts the pen cartridge into another pen cartridge with a wanted color while writing.

As described above, the conventional ball pointed pen with at least two colors has the disadvantage in that the user has to push the manipulation button with the thumb to change the pen cartridge into another pen cartridge with a wanted color after releasing the ball pointed pen or temporarily stopping writing.

Therefore, the conventional two-color ball pointed pens have inconvenience in writing while promptly changing the pen cartridge with the wanted color in the case that the user needs to write in various colors.

### SUMMARY OF THE INVENTION

Accordingly, the present invention has been made to solve the above-mentioned problems occurring in the prior arts, and it is an object of the present invention to provide a two-color ball pointed pen, in which two pen cartridges with different colors are embedded in one case having a structure to easily distinguish the colors of the pen cartridges such that a user can conveniently and rapidly change the color of the ball pointed pen into a wanted color at any time while writing.

It is another object of the present invention to provide a two-color ball pointed pen, which allows the user to select and change the color of the pen cartridge just by a simple action to rotate the ball pointed pen with a finger which grasps the ball pointed pen while directly checking the color of the ball pointed pen without dispersing the grasping posture of the fingers, so that the user can easily and rapidly use the ball pointed pen with a wanted color.

It is a further object of the present invention to provide a two-color ball pointed pen, which may have not only two colors but also four colors and may have a highlighter pen attached thereto.

To accomplish the above object, according to the present invention, there is provided a two-color ball pointed pen including: two-color pen cartridges joined to one side of a case; a highlighter pen joined to the other side of the case; and a transparent cap joined to an assembly hole of one side of the case to which the two-color pen cartridges are joined so as to allow a user to see colors of the two-color pen cartridges from the outside.

In another aspect of the present invention, there is a two-color ball pointed pen including: two-color pen cartridges joined to one side of a case; other two-color pen cartridges joined to the other side of the case; and transparent caps joined to assembly holes of both sides of the case to which the two-color pen cartridges are joined so as to allow a user to see colors of the two-color pen cartridges from the outside.

In a further aspect of the present invention, there is a two-color ball pointed pen including: two-color pen cartridges joined to one side of a case; and a transparent cap joined to an assembly hole of one side of the case to which the two-color pen cartridges are joined so as to allow a user to see colors of the two-color pen cartridges from the outside.

Moreover, the case includes an inner case having an assembly tube formed at one side thereof in such a way that the two-color pen cartridges are joined to the assembly tube and another assembly tube formed at the other side in such a way that an ink cartridge of the highlighter pen is joined to the assembly tube.

Furthermore, the transparent cap joined to the case is a colored cap having colored portions painted with the same colors as the two-color pen cartridges so as to allow the user to see the colors of the two-color pen cartridges from the outside.

According to the preferred embodiments of the present invention, because the two-color ball pointed pen has the two pen cartridges with different colors which are embedded in one case and the user can easily distinguish the colors of the pen cartridges through the front end of the writing instrument, the user can rapidly select the pen cartridge of the wanted color without any difficulty while writing.

Moreover, the two-color ball pointed pend according to the preferred embodiments of the present invention allows the user to rapidly write in a wanted color by selecting and changing the color of the pen cartridge just by the simple action to rotate the ball pointed pen with the finger which grasps the ball pointed pen while writing because the user can distinguish the color of the ball pointed pen in the grasping state of the ball pointed pen.

Furthermore, the two-color ball pointed pen may have a highlighter pen attached thereto as well as the two-color ball pointed pen.

### BRIEF DESCRIPTION OF THE DRAWINGS

The above and other objects, features and advantages of the present invention will be apparent from the following detailed description of the preferred embodiment of the present invention in conjunction with the accompanying drawings, in which:

FIG. 1 is a perspective view of a two-color ball pointed pend according to a first preferred embodiment of the present invention;

FIG. 2 is a sectional view of the two-color ball pointed pen;

FIG. 3 is an enlarged sectional view, in section, of essential parts of the two-color ball pointed pen;

FIG. 4 is a perspective view of a two-color ball pointed pend according to a second preferred embodiment of the present invention;

FIG. 5 is a front view of FIG. 4;

FIG. 6 is a sectional view of FIG. 4;

FIG. 7 is a sectional view of a two-color ball pointed pend according to a third preferred embodiment of the present invention; and

FIG. 8 is a front view of a two-color ball pointed pen according to a fourth preferred embodiment of the present invention.

### DETAILED DESCRIPTION OF THE PREFERRED EMBODIMENT

Reference will be now made in detail to the preferred embodiments of the present invention with reference to the attached drawings. FIG. 1 is a perspective view of a two-color ball pointed pen according to a first preferred embodiment of the present invention, FIG. 2 is a sectional view of the two-color ball pointed pen, and FIG. 3 is an enlarged sectional view, in section, of essential parts of the two-color ball pointed pen.

The two-color ball pointed pen according to the preferred embodiment of the present invention includes: a case 1 of a tube shape; two pen cartridges 3 and 3′ with different colors (hereinafter, called ‘two-color cartridge’) embedded in the case 1; and a transparent cap 4 for allowing a user to directly check colors of the pen cartridges 3 and 3′ joined to the case 1 from the outside, so that the user can rapidly select and use the ball pointed pen with a wanted color.

Moreover, a highlighter pen 5 is joined to the other side of the case 1 that the two-color pen cartridges 3 and 3′ are joined, so that the user can use the highlighter pen 5 together with the ball pointed pen.

Hereinafter, the present invention will be described in more detail.

The case 1 has an inner case 2 embedded therein, the two-color pen cartridges 3 and 3′ joined to one side of the inner case 2, and the transparent cap 4 forcedly fit to an assembly hole 11 of the case 1 in which the inner case 2 is embedded. Additionally, an ink cartridge of a highlighter pen 5 is joined to the other side of the inner case 2.

The transparent cap 4 joined to the case 1 is joined in such a manner that tips 31 and 31′ of the two-color pen cartridges 3 and 3′ embedded in the inner case 2 respectively protrude to the outside. The transparent cap 4 has insertion holes 41 and 41′ allowing that the tips 31 and 31′ of the two-color pen cartridges 3 and 3′ are exposed to the outside.

The inner case 2 includes a central wall 22 and assembly tubes 21 and 21′ formed at both sides thereof, so that the two-color pen cartridges 3 and 3′ is joined to one side assembly tube 21 and the ink cartridge 51 of the highlighter pen 5 is joined to the other side assembly tube 21′, and then, the inner case 2 is joined into the case 1.

Of course, the outer diameter of the inner case 2 is smaller than the inner diameter of the case 1.

As described above, the transparent cap 4 is joined to one side of the case 1 in which the inner case 2 is embedded, such that the two-color pen cartridges 3 and 3′ are joined to the case 1. The ink cartridge 51 of the highlighter pen 5 is joined to the other side assembly tube 21′ of the inner case 2 to which the two-color pen cartridges 3 and 3′ are joined, and the highlighter pen 5 is exposed through a joining hole 12 formed at the other side of the case 1.

Lids 6 and 6′ are detachably joined to both sides of the case 1 to which the two-color pen cartridges 3 and 3′ and the highlighter pen 5 are joined.

Of course, two or more of the two-color pen cartridges 3 and 3′ which are inserted into the inner case 2 and are protrudingly joined through the transparent cap 4 are mounted.

Moreover, FIGS. 4 to 6 illustrate a two-color ball pointed pen according to a second preferred embodiment of the present invention.

In this embodiment, a transparent cap 4 is joined to one side of a case 1 in which an inner case 2 and two-color pen cartridges 3 and 3′ are joined to the case 1, and the same transparent cap 4′ as the transparent cap 4 is joined to a joining hole 12 formed at the other side of the case 1 and other two-color pen cartridges 30 and 30′ are joined to the other side of the case 1.

In the second preferred embodiment, the two-color pen cartridges 30 and 30′ are joined to an assembly tube 21′ of the other side of the inner case 2 in which the two-color pen cartridges 3 and 3′ and a transparent cap 4′ is joined to the joining hole 12 of the case 1, so that two-color pen cartridges 3 and 3′ and 30 and 30′ are respectively disposed at both sides of the case 1.

As described above, in the case that the two-color pen cartridges 3 and 3′ and 30 and 30′ with different colors are respectively disposed at both sides of the case 1, the two-color pen cartridges 3 and 3′ disposed at one side and the two-color pen cartridges 30 and 30′ disposed at the other side may have different colors.

Additionally, FIG. 7 illustrates a two-color ball pointed pen according to a third preferred embodiment of the present invention.

In the third preferred embodiment, the two-color pen cartridges 3 and 3′ are disposed only at the one side of the case 1 and the highlighter pen 5 is omitted.

As described above, in the case that the two-color pen cartridges 3 and 3′ are disposed only at the one side of the case 1, the inner case 2 is not needed, and a fixing cap 7 may be joined to the joining hole 12 of the opposite side so as to fix the two-color pen cartridges 3 and 3′ inside the case 1.

In the case that the two-color pen cartridges 3 and 3′ are disposed only at the one side of the case 1, besides the highlighter pen 5, other writing instrument may be disposed at the opposite side.

In addition, FIG. 8 illustrates a two-color ball pointed pen according to a fourth preferred embodiment of the present invention.

In the fourth preferred embodiment, a colored cap 8 is disposed for allowing the user to check colors of the transparent caps 4 and 4′ of the case 1, to which the two-color pen cartridges 3 and 3′ and 30 and 30′ are joined, from the outside.

That is, the colored cap 8 has colored portions 81 and 81′ which are painted in the same colors as the two-color pen cartridges 3 and 3′ so that the user can see the colors of the two-color pen cartridges 3 and 3′ from the outside and distinguish a wanted color through the colors of the colored portions 81 and 81′.

FIG. 8 illustrates the two-color ball pointed pen having the highlighter pen 5, but as shown in FIGS. 4 to 6, the two-color pen cartridges 3 and 3′ and the transparent caps 4 and 4′ may be applied to both sides of the case 1.

Because the user can easily distinguish the colors of the two-color pen cartridges 3 and 3′ through the transparent cap 4 while writing grasping the ball pointed pen in his or her hand, the user can easily and rapidly select and use a wanted color just by rotating the case 1 in the direction of the wanted color of the two-color pen cartridges 3 and 3′ with the hand grasping the case 1.

That is, because the user can naturally check the wanted color of the ball pointed pen through the transparent cap 4 while writing, the user can rapidly and conveniently change the pen cartridge into the wanted color just by rotating the case 1 in the direction of the wanted color with the hand grasping the case 1.

Therefore, the two-color ball pointed pen according to the preferred embodiments of the present invention includes the two-color pen cartridges 3 and 3′ inserted in one case, and thus, provides easiness and convenience in use because the user can easily and rapidly select the pen cartridge of the wanted color.

The two-color ball pointed pen according to the preferred embodiment of the present invention has two-color pen cartridges with different colors which are embedded in one side of the case in such a way that the user can directly check the colors from the outside, so that the user can directly select and use the pen cartridge with a wanted color.

The two-color ball pointed pen according to the preferred embodiment of the present invention has the assembly tubes which are joined to the inside of the case and the two-color pen cartridges are embedded in the assembly tubes.

The transparent cap is forcedly fit to the assembly hole of the case to which the two-color pen cartridges are joined in such a way that the two-color pen cartridges protrude outward through the transparent cap joined to the case, so that the user can distinguish the colors of the two-color pen cartridges from the outside at any time.

Moreover, the two-color ball pointed pen according to the preferred embodiment of the present invention has two-color pen cartridges embedded in one side of the case and the highlighter pen disposed at the other side of the case, so that the user can use the two-color ball pointed pen and the highlighter pen together.

The two-color ball pointed pen combined with the highlighter pen is embedded in the inner case of the case, and the inner case has the assembly tubes divided into two based on the central wall, so that the ink cartridge of the highlighter pen and the two-color pen cartridges are respectively joined to both sides of the case.

As described above, the ink cartridge of the highlighter pen is joined to the assembly tube of the one side of the inner case, the inner case is joined to the inside of the case, and then, the two-color pen cartridges are joined to the assembly tube of the other side of the inner case, such that the two-color ball pointed pen has the two-color pen cartridges at one side of the case and the highlighter pen at the other side of the case.

Moreover, the two-color ball pointed pen according to the preferred embodiment of the present invention has two two-color pen cartridges respectively joined to both sides of the case, such that the user can use four-color ball pointed pen disposed in a single body.

As described above, because the two-color ball pointed pen according to the present invention has two-color pen cartridges with different colors embedded in one case and the user can rapidly select and use the ball pointed pen with a wanted color, the present invention can be used as two-color ball pointed pen, multi-color ball pointed pen, and a ball pointed pen combined with a highlighter pen according to use purposes, namely, for writing a memo or for shorthand.

What is claimed is:

1. A two-color ball pointed pen comprising:
two-color pen cartridges(3,3′) joined to one side of a case(1);
a highlighter pen(5) joined to the other side of the case(1); and
a transparent cap(4) joined to an assembly hole(11) of one side of the case(1) to which the two-color pen cartridges(3,3′) are joined so as to allow a user to see colors of the two-color pen cartridges(3,3′) from the outside.

2. A two-color ball pointed pen comprising:
two-color pen cartridges(3,3′) joined to one side of a case(1);
other two-color pen cartridges(30,30′) joined to the other side of the case(1); and
transparent caps(4) (4′) joined to assembly holes(11) (12) of both sides of the case(1) to which the two-color pen cartridges(3, 3′) (30,30′) are joined so as to allow a user to see colors of the two-color pen cartridges(3,3′) (30,30′) from the outside.

3. A two-color ball pointed pen comprising:
two-color pen cartridges(3,3′) joined to one side of a case(1); and
a transparent cap(4) joined to an assembly hole(11) of one side of the case(1) to which the two-color pen cartridges(3,3′) are joined so as to allow a user to see colors of the two-color pen cartridges(3,3′) from the outside.

4. The two-color ball pointed pen according to claim 1, wherein the case(1) comprises an inner case(2) having an assembly tube(21) formed at one side thereof in such a way that the two-color pen cartridges(3,3′) are joined to the assembly tube(21) and another assembly tube(21′) formed at the other side in such a way that an ink cartridge(51) of the highlighter pen(5) is joined to the assembly tube(21′).

5. The two-color ball pointed pen according to one of claim 1, wherein the transparent cap(4) (4′) joined to the case(1) is a colored cap(8) having colored portions(81,81′) painted with the same colors as the two-color pen cartridges(3,3′) so as to allow the user to see the colors of the two-color pen cartridges from the outside.

6. The two-color ball pointed pen according to one of claim 2, wherein the transparent cap(4) (4′) joined to the case(1) is a colored cap(8) having colored portions(81,81′) painted with the same colors as the two-color pen cartridges(3,3′) so as to allow the user to see the colors of the two-color pen cartridges from the outside.

7. The two-color ball pointed pen according to one of claim 3, wherein the transparent cap(4) (4′) joined to the case(1) is a colored cap(8) having colored portions(81,81′) painted with the same colors as the two-color pen cartridges(3,3′) so as to allow the user to see the colors of the two-color pen cartridges from the outside.
